(19) United States
(12) Patent Application Publication
(10) Pub. No.: US 2023/0125572 A1
(43) Pub. Date: Apr. 27, 2023

(54) ATTACHMENT FOR WORKING MACHINE

(71) Applicant: J.C. BAMFORD EXCAVATORS LIMITED, Uttoxeter (GB)

(72) Inventors: Amol Nalawade, Uttoxeter (GB); Ninad Kulkarni, Uttoxeter (GB); Paresh Pimpalkar, Uttoxeter (GB); Jatin Behal, Uttoxeter (GB); Atul Deshmukh, Uttoxeter (GB); Sanjeev Arora, Faridabad (IN)

(73) Assignee: J.C. BAMFORD EXCAVATORS LIMITED, Uttoxeter (GB)

(21) Appl. No.: 17/971,533

(22) Filed: Oct. 21, 2022

(30) Foreign Application Priority Data
Oct. 21, 2021 (IN) 202111047887

(51) Int. Cl. E02F 3/96; B66C 1/48; B66C 1/42

(52) U.S. Cl. CPC E02F 3/963; B66C 1/48; B66C 1/425

(57) ABSTRACT

A pipe handling attachment for a working machine is configured to support a pipe and includes a mounting component configured to couple the pipe handling attachment to the working machine. A boom includes a first support arrangement for supporting a first portion of the pipe, and a second support arrangement, spaced apart from the first support arrangement, for supporting a second portion of the pipe. A distance between the first support arrangement and the second support arrangement is variable, and including adjusting mechanism configured to adjust the distance between the first support arrangement and the second support arrangement. The adjusting mechanism is configured to be operated manually.

### FIELD

The present disclosure relates to a pipe handling attachment for a working machine, the pipe handling attachment being configured to support a pipe, and a working machine comprising said pipe handling attachment.

### BACKGROUND

Replacing and installing pipe work often involves digging underneath highways in heavily populated areas. Furthermore, such work typically requires the use of heavy machinery, not only to carry out the required excavation, but also to lift and manipulate pipe work due to the heavy weight of pipes used (e.g. concrete pipes) and the size of pipes required.

The use of such machinery on relatively small and restricted worksites, in addition to the presence of construction workers and other persons required for the work to be carried out, results in a congested work site and the safety concerns that accompany this.

Furthermore, the more machines that are used at a given worksite, the greater the associated cost.

It is an aim of the present disclosure to address or reduce some of the problems associated with the prior art.

### SUMMARY

In a first aspect a pipe handling attachment for a working machine is provided, the pipe handling attachment configured to support a pipe and comprising:
a. a mounting component configured to couple the pipe handling attachment to a working machine;
b. a boom having a first support arrangement for supporting a first portion of a pipe, and a second support arrangement, spaced apart from the first support arrangement, for supporting a second portion of said pipe, wherein a distance between the first support arrangement and the second support arrangement is variable; and
c. an adjusting mechanism, configured to adjust the distance between the first support arrangement and the second support arrangement, and wherein the adjusting mechanism is configured to be operated manually.

By providing a pipe handling attachment that can be coupled to a working machine, working machines that are already present at a given worksite can be used to lift and handle pipes. For example, a backhoe loader or excavator may be required to dig up a section of road in order to access underground pipe work. The same backhoe loader or excavator can then be fitted with a pipe handling attachment as disclosed herein, to lift and position pipes in a desired location. In this way, the number of working machines required at a worksite can be reduced, thereby improving safety and reducing cost. This is particularly beneficial where there is limited space available at the worksite.

Using a working machine fitted with a pipe handling attachment two lift and position heavy pipe work improves safety and reduces the amount of heavy lifting work required by the construction workers.

The pipe handling attachment includes an adjusting mechanism to vary the distance between the first support arrangement and the second support arrangement. In this way, the pipe handling attachment can be adjusted for use with pipes having a range of lengths and can be configured to securely lift and position said pipes.

Furthermore, the adjusting mechanism of the pipe handling attachment disclosed herein is configured to be operated manually. Therefore, no hydraulic or vacuum mechanisms are required in order to safely and securely support a pipe. As a result, working machines which do not provide hydraulic or vacuum power to the pipe lifting attachment can be used. Therefore, a more versatile pipe handling attachment is provided which comprises a simpler mechanism for coupling the pipe handling attachment to a pipe.

Optionally, the attachment means is configured such that, when in use, a longitudinal axis of the boom is substantially parallel to a longitudinal axis of a pipe supported by the pipe handling attachment.

In some embodiments, the distance between the first support arrangement and the second support arrangement extends along the longitudinal axis along the beam. In this way, the longitudinal axis extending between the first and second support arrangements is positioned substantially parallel to a longitudinal axis of a pipe when the pipe is supported by the pipe handling attachment.

Since the distance between the first support arrangement and the second support arrangement is variable, the pipe handling attachment can be adjusted to use for pipes having differing lengths.

Optionally the first support arrangement is provided at a first end of the boom and the second support arrangement is provided at a second end of the boom, distal the first end.

In this way, a compact pipe handling attachment is provided.

Optionally the boom is a telescopic boom comprising an outer stationary arm and an inner moving arm (e.g. a first inner moving arm), arranged such that the distance between the first support arrangement and the second support arrangement is varied by extending and/or retracting the telescopic boom. In some embodiments, the first inner moving arm is configured to extend from a first end of the boom.

In this way, a simple and effective means for altering the distance between the first support arrangement and the second support arrangement is provided, such that a range of pipe lengths can be supported by the pipe handling attachment.

In other words, the adjusting mechanism is configured to adjust the distance between the first support arrangement and the second support arrangement by extending and/or retracting the telescopic boom.

Optionally the adjustment mechanism comprises a first pulley arrangement having a pulley wheel and a rope, cable, belt and/or chain.

This provides a simple mechanical arrangement for moving the first inner moving arm with respect to the outer stationary arm. Accordingly, no hydraulics or other form of power is required to adjust the distance between the first support arrangement and the second support arrangement. Furthermore, such a pulley arrangement is easy to operate and repair on site if necessary.

Alternatively, the first inner moving arm can be manually pulled and/or pushed with respect to the outer stationary arm in order to adjust the distance between the first support arrangement and the second support arrangement.

Optionally the first inner moving arm and the outer stationary arm are coupled via the first pulley arrangement, wherein the first pulley arrangement is configured such that rotation of the pulley wheel causes relative movement of the first inner moving arm and outer stationary arm.

Optionally the pulley wheel is mounted on the outer stationary arm or the first inner moving arm and is configured to be rotated manually about a shaft, and the rope, cable, belt and/or chain is coupled to the other of the outer stationary arm and the first inner moving arm, such that rotation of the pulley wheel causes movement of the fist inner moving arm in a linear direction.

In this way, a simple means for adjusting the distance between the first support arrangement and the second support arrangement is provided.

Optionally the pulley wheel is a first pulley wheel, and the first pulley arrangement comprises a second pulley wheel, wherein both the first and second pulley wheels are mounted on the outer stationary arm or the first inner moving arm, the first pulley wheel and the second pulley wheel each being configured for rotation about a respective shaft, such that rotation of the first pulley wheel and/or second pulley wheel (e.g. in a first angular direction) causes movement of the first inner moving arm in a first linear direction and/or rotation of the first pulley wheel and/or second pulley wheel (e.g.in a second angular direction) causes movement of the inner moving arm in a second linear direction.

In exemplary embodiments, the first linear direction corresponds to extension or retraction of the first inner moving arm. In exemplary embodiments, the second linear direction corresponds to extension or retraction of the first inner moving arm.

In this way, extension and retraction of the telescopic boom can be controlled by rotation of the first pulley wheel and/or the second pulley wheel.

Optionally the first pulley wheel and/or second pulley wheel is configured to be rotated manually.

Optionally the boom comprises a second inner moving arm configured to extend from a second end of the boom, such that the boom is configured to extend and/or retract at both the first and second ends.

In this way, a more versatile pipe handling attachment is provided in which each of the first inner moving arm and second inner moving arm is moveable to adjust the distance between the first support arrangement and the second support arrangement. This facilitates lining up the pipe handling attachment with a pipe to be lifted and minimises the amount of manoeuvring required by the working machine to which the pipe handling attachment is attached in order to couple the pipe handling attachment to a pipe.

Optionally the second inner moving arm and the outer stationary arm are coupled via a second pulley arrangement. Optionally, wherein the second pulley arrangement is configured to cause relative movement of the second inner moving arm and outer stationary arm. Optionally, the second pulley arrangement is substantially the same as the first pulley arrangement, the only difference being that the first pulley arrangement is coupled to the first inner moving arm, and the second pulley arrangement is coupled to the second inner moving arm.

Optionally the second pulley arrangement comprises a pulley wheel and a rope, cable, belt and/or chain.

Optionally, the second pulley arrangement is configured such that rotation of the pulley wheel causes relative movement of the second inner moving arm and outer stationary arm.

Optionally, the pulley wheel of the second pulley arrangement is mounted on the outer stationary arm or the second inner moving arm and is configured to be rotated manually about a shaft, and the rope, cable, belt and/or chain is coupled to the other of the outer stationary arm and the second inner moving arm, such that rotation of the pulley wheel causes movement of the second inner moving arm in a linear direction.

Optionally, the pulley wheel of the second pulley arrangement is a first pulley wheel of the second pulley arrangement, and the second pulley arrangement comprises a second pulley wheel, wherein both the first and second pulley wheels are mounted on the outer stationary arm or the first inner moving arm, the first pulley wheel and the second pulley wheel each being configured for rotation about a respective shaft, such that rotation of the first pulley wheel and/or second pulley wheel (e.g. in a first angular direction) causes movement of the second inner moving arm in a second linear direction and/or rotation of the first pulley wheel and/or second pulley wheel (e.g.in a second angular direction) causes movement of the second inner moving arm in a first linear direction.

Optionally, the first pulley wheel and/or second pulley wheel of the second pulley arrangement is configured to be rotated manually.

Optionally, the first and second pulley arrangements are configured to be operated independently.

Optionally the first inner moving arm and the second inner moving arm are arranged to extend and/or retract in unison.

By extending and/or retracting the first inner moving arm and second inner moving arm in unison, a more balanced pipe handling attachment is provided in which the weight of a pipe supported by the pipe handling attachment is evenly supported across the pipe handling attachment.

Optionally the pulley attachment comprises a third pulley wheel coupled to the first and second pulley wheels respectively, such that rotation of the first pulley wheel in the first angular direction causes rotation of the second pulley wheel in the first angular direction, and/or rotation of the first pulley wheel in the second angular direction causes rotation of the second pulley wheel in the second angular direction.

In this way, rotation of the first pulley wheel causes rotation of the second pulley wheel in the same direction, and vice versa.

This enables extension and retraction of the first inner moving arm to be achieved by rotating only one of the first and second pulley wheels. This provides a simpler means for operating the adjustment mechanism.

Optionally rotation of the first and/or second pulley wheel in a first angular direction causes movement of the first inner moving arm in a first linear direction and rotation of the first and/or second pulley wheel in a second angular direction causes movement of the inner moving arm in a second linear direction.

Optionally the second inner moving arm is coupled to the third pulley (e.g. via a rack and pinion arrangement), such that rotation of the first and/or second pulley wheel in the first angular direction causes movement of the second inner moving arm in the second linear direction, and/or rotation of the first and/or second pulley wheel in the second angular direction causes movement of the second inner moving arm in the first linear direction.

In this way, the first inner moving arm and the second inner moving arm are configured to be extended and/or retracted in unison. Extension and/or retraction of the first inner moving arm and second inner moving arm is achieved simply by rotating the first pulley wheel and/or the second pulley wheel.

Optionally the first support arrangement is provided at a free end of the first inner moving arm and the second support arrangement is provided at a free end of the second inner moving arm.

In other words, the first support arrangement and the second support arrangement are provided at distal ends of the boom. In other words, the first support arrangement is provided at a first end of the boom and the second support arrangement is provided at the second end of the boom. This provides a compact arrangement for supporting pipes having varying length.

Optionally the first support arrangement and second support arrangement each comprise a support projection configured to engage an interior wall of a pipe supported by the pipe handling attachment, wherein at least one of the support projections is pivotally mounted on the boom and configured for manual rotation.

This provides a simple and secure means of carrying a pipe using the pipe handling attachment. In some embodiments, a locking mechanism is provided which is configured to lock the at least one hook which is pivotally mounted on the boom in place.

Optionally the pipe handling attachment comprises a locking arrangement configured such that, when in a locked state, the locking arrangement inhibits or prevents adjustment of the distance between the first support arrangement and the second support arrangement.

In this way, the distance between the first support arrangement and the second support arrangement can be fixed at a desired distance.

Optionally the first support arrangement and the second support arrangement comprise a first support structure, and wherein the pipe handling attachment further comprises a second support structure configured to support said pipe at a third portion of said pipe, and optionally at a fourth portion of said pipe.

In some instances, the second support structure may be a supplementary support structure which is used together with the first support structure to support a pipe. In some cases, one or other of the first support structure and second support structure may be used to support a pipe, for example, depending on the size, dimensions and/or type of the pipe.

Optionally the second support structure comprises a third support arrangement for supporting the third portion of said pipe, optionally wherein the secondary support structure also comprises a fourth support arrangement for supporting the fourth portion of said pipe, wherein the third support arrangement, and optionally the fourth support arrangement, are located between the first and second support arrangements.

In exemplary embodiments, the first support structure, optionally together with the second support structure, can be used to support pipes having a length in the range of 1 m-4 m, for example, 1.5 m-3 m, for example, 1.5 m-2.6 m

In exemplary embodiments, the second support structure may be used to support pipes having a length of 0.3 m or greater, for example, 0.5 m or greater.

Optionally the second support structure comprises a fourth support arrangement, wherein the adjusting mechanism is a first adjusting mechanism, and wherein the pipe handling attachment comprises a second adjusting mechanism configured to adjust a distance between the third support arrangement and the fourth support arrangement, and wherein the second adjusting mechanism is configured to be operated manually.

In this way, the second support structure of the pipe handling attachment can be adjusted for use with pipes having a range of lengths and configured to securely lift and position said pipes.

Furthermore, the second adjusting mechanism of the pipe handling attachment disclosed herein is configured to be operated manually. Therefore, no hydraulic or vacuum mechanisms are required in order to safely and securely support a pipe using the second support structure. As a result, working machines which do not provide hydraulic or vacuum power to the pipe lifting attachment can be used. Therefore, a more versatile pipe handling attachment is provided which comprises a simple mechanism for coupling the pipe handling attachment to a pipe.

Optionally the boom is a first boom and wherein the second support structure comprises a second boom, wherein the second boom is a telescopic boom configured such that the distance between the third support arrangement and fourth support arrangement is variable by extension and/or retraction of the second telescopic boom.

In exemplary embodiments, the second boom comprises an inner moving arm and a stationary arm configured for relative movement there between. In exemplary embodiments, the second boom may comprise a first inner moving arm and a second inner moving arm configured to extend from distal ends of the stationary arm of the second boom.

In some embodiments, one or more pulley arrangements, similar to those described in relation to the first boom is used to extend and/or retract the first and/or second inner moving arms of the second boom.

In some embodiments, the first and/or second inner moving arms of the second boom can simply be pushed or pulled with respect to the stationary arm to adjust a distance between the third support arrangement and the fourth support arrangement.

In some embodiments, the third support arrangement is provided at a distal end of the first inner arm of the second boom. In some embodiments, the fourth support arrangement is provided at a distal end of the second inner moving arm of the second boom.

Optionally the third support arrangement comprises a rope, cable, belt and/or chain for supporting said pipe at said third portion, optionally wherein the second support structure comprises a fourth support arrangement and wherein the fourth support arrangement comprises a belt for supporting said pipe at said fourth portion.

In this way, pipes which cannot be supported by the first support structure can be supported using the second support structure. For example, pipes which are too short or which have a diameter that is too small to be used with the first support structure can be supported by the second support structure.

In some embodiments, the second support structure can be used to supplement the first support structure when lifting pipes which are particularly long and/or heavy.

Optionally the pipe handling attachment defines a longitudinal axis along which the first support arrangement and the second support arrangement are provided, wherein the mounting arrangement is configured to permit rotation of the pipe handling attachment about a second axis substantially perpendicular to said longitudinal axis.

In other words, the second axis can be thought of as a roll axis about which the pipe handling attachment can rotate (i.e. roll rotation).

This facilitates manipulation of a pipe supported by the pipe handling attachment. This also facilitates coupling of the pipe handling attachment to a pipe to be lifted.

Optionally the pipe handling attachment defines a longitudinal axis along which the first support arrangement and the second support arrangement are provided, wherein the mounting arrangement is configured to permit rotation of the pipe handling attachment about a third axis substantially perpendicular to the longitudinal axis and the second axis.

In other words, the third axis can be thought of as a yaw axis about which the pipe handling attachment can rotate (i.e. yaw rotation). In this way, manipulation of a pipe supported by the pipe handling attachment is facilitated. Manipulation of the pipe handling attachment to align with a pipe to be lifted is also facilitated.

According to a further aspect, a working machine is provided comprising a pipe handling attachment as disclosed herein.

In exemplary embodiments, the working machine may be a back hoe loader, excavator, or any other suitable working machine.

It will be appreciated that the optional features described herein may apply to any aspect disclosed herein. All combinations contemplated are not recited explicitly for the sake of brevity.

### BRIEF DESCRIPTION OF THE DRAWINGS

Embodiments will now be described by way of example only and with reference to the accompanying drawings, in which:

FIG. 1a illustrates a perspective view of a pipe handling attachment according to a first embodiment attached to an arm assembly of a working machine;

FIG. 1b illustrates a close-up perspective view of the pipe handling attachment of FIG. 1a;

FIG. 2a shows a side view of a working machine to which a pipe handling attachment disclosed herein is attached;

FIG. 2b shows a side view of a working machine to which a pipe handling attachment disclosed herein is attached, wherein the pipe handling attachment is coupled to a pipe;

FIG. 3 shows a side view of the pipe handling attachment of FIG. 1a;

FIG. 4a shows a top down view of the pipe handling attachment of FIG. 1a when fully retracted;

FIG. 4b shows a top down view of the pipe handling attachment of FIG. 1a when fully extended;

FIG. 5 shows a perspective view of a first end of the pipe handling attachment of FIG. 1a including a pulley arrangement;

FIG. 6 shows a perspective view of a first end of the pipe handling attachment of FIG. 1a including a portion of a pulley arrangement;

FIG. 7 shows a cross section view of a first end of the pipe handling attachment of FIG. 1a including a portion of a pulley arrangement;

FIG. 8 shows a cut away view of a first end of the pipe handling attachment of FIG. 1a including a pulley arrangement;

FIG. 9 shows a side view of a first end of the pipe handling attachment of FIG. 1a including a support projection moving between an engaged position and a disengaged position;

FIG. 10 illustrates a perspective view of a pipe handling attachment according to a second embodiment; and

FIG. 11 shows a close-up view of a second end of the pipe handling attachment of FIG. 10.

### DETAILED DESCRIPTION

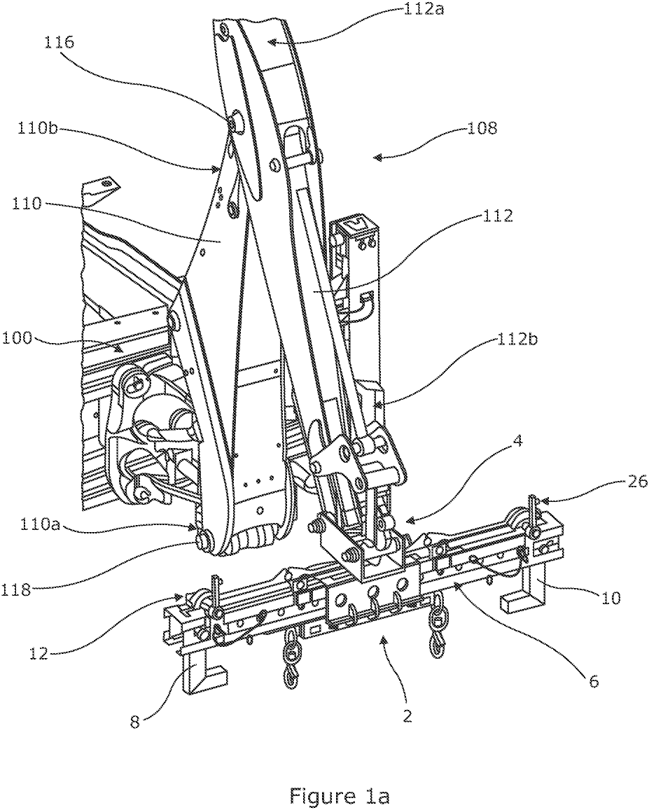

With reference to FIGS. 1a and 1b there is shown a pipe handling attachment 2 coupled to a working machine, illustrated schematically at reference numeral 100.

A working machine is an off-highway vehicle, for example those used in construction industries (e.g. backhoe loaders, excavators, slew excavators, telescopic handlers, forklifts, skid-steer loaders, dump trucks, bulldozers, graders), agricultural industries (tractors, combine harvesters, self-propelled harvesters and sprayers), quarrying (e.g. loading shovels, aggregate crushing equipment), and forestry (timber harvesters, feller bunchers).

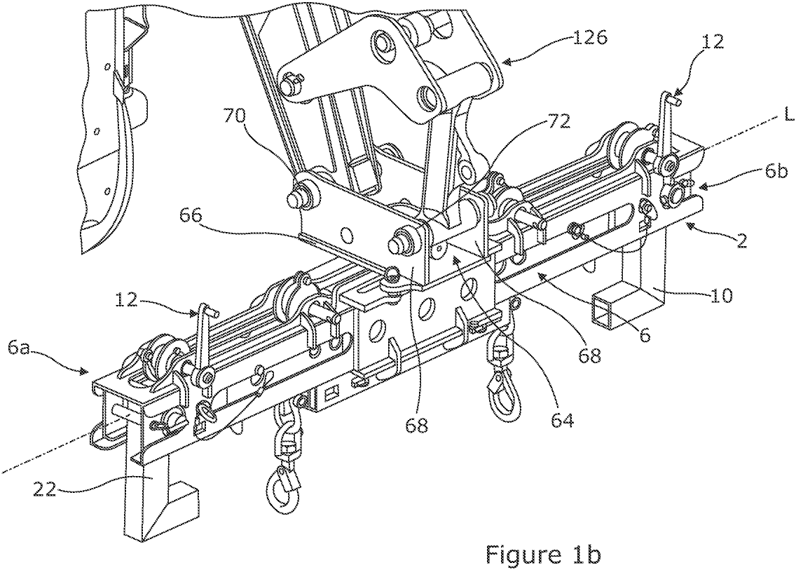

By way of example, the working machine 100 may be an excavator as shown in FIG. 2a. The excavator 100 includes a chassis 102 and a superstructure 104 carrying an operator station 114 from which an operator can control the vehicle. The superstructure 104 is mounted on the chassis 102. Ground engaging transport means in the form of a pair of tracks 106 are provided on the chassis 102 to move the machine over the ground.

Attached to the vehicle superstructure 104 is an arm assembly 108, the arm assembly includes a first arm 110 and a second arm 112. The arm assembly 108 is coupled to the pipe handling attachment 2.

The first arm 110 is pivotally mounted to the superstructure 104 at a first end 110a by a pivot (not shown). A first end 112a of the second arm 112 is pivotally mounted via pivot 116 to a second end 110b of the first arm 110. Pivot 116 is orientated horizontally. The pipe handling attachment 2 is pivotally mounted via pivot 118 to a second end 112b of second arm 112. Pivot 118 is orientated horizontally.

A first hydraulic actuator in the form of a first hydraulic ram (not shown) has a first end pivotally attached to the superstructure 104 and a second end pivotally attached to the first arm 110 part way between the first and second ends 110a,b of the first arm 110. A second hydraulic actuator in the form of a second hydraulic ram 122 has a first end pivotally attached to the first arm 110 part way between the first and second ends 11 0a,b of the first arm 110 and a second end pivotally attached to the second arm 112 proximate the first end 112a of the second arm 112. A third hydraulic actuator in the form of a third hydraulic ram 120 has a first end pivotally attached to the second arm 112 proximate the first end 112a of the second arm 112 and a second end pivotally attached to a linkage mechanism 126 proximate the second end 112b of the second arm 112. The linkage mechanism 126 per se is known and simply converts extension and retraction movement of the third hydraulic ram 120 into rotary movement of the pipe handling attachment 2 about pivot 118.

Extension of the first hydraulic ram (not shown) causes the first arm 110 to raise, and contraction of the first hydraulic ram (not shown) causes lowering of the first arm 110. Extension of the second ram 122 causes the second arm 112 to pivot in an anticlockwise direction (when viewing FIG. 2a) about pivot 116, and retraction of the second hydraulic ram 122 causes the second arm 112 to move in a clockwise direction when viewing FIG. 2a about pivot 116. Extension of the third hydraulic ram 120 causes the pipe handling attachment 2 to move in an anticlockwise direction (when viewing FIG. 2a) about pivot 118, and retraction of the third hydraulic ram 120 causes the pipe handling attachment 2 to move in a clockwise direction about pivot 118(when viewing FIG. 2a).

FIG. 2b illustrates the pipe handling attachment 2 when coupled to a pipe 124.

Returning to FIGS. 1a and 1b, the pipe handling attachment 2 includes a mounting component 4 configured to couple the pipe handling attachment 2 to the working machine 100. The pipe handling attachment 2 also includes a boom 6 including a first support arrangement 8 and a second support arrangement 10, spaced apart from the first support arrangement 8. The first support arrangement 8 is configured to support a first portion of a pipe and the second support arrangement 10 is configured to support a second portion of a pipe.

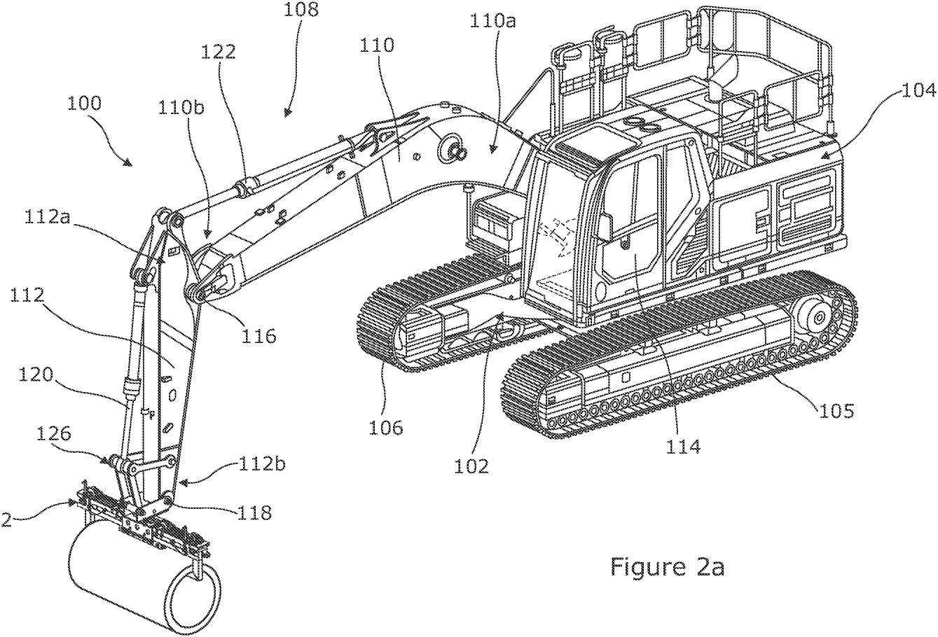

The first support arrangement 8 and the second support arrangement 10 are spaced apart and the pipe handling attachment 2 is arranged such that a distance D (shown in FIG. 3) between the first support arrangement 8 and the second support arrangement 10 is variable.

The pipe handling attachment 2 also includes an adjustment mechanism 12 which is arranged to adjust the distance D between the first support arrangement 8 and the second support arrangement 10. As will be described in more detail below, the adjustment mechanism 12 is arranged to be operated manually such that the distance D between the first support arrangement 8 and the second support arrangement 10 can be varied manually.

As illustrated in FIG. 1b, the boom 6 has a longitudinal axis L. In use and when a pipe is coupled to the pipe handling attachment 2, the longitudinal axis L of the boom 6 is substantially parallel to a longitudinal axis of the pipe supported by the pipe handling attachment 2.

The boom 6 has a first end 6a and a second end 6b. The first support arrangement 8 is provided at the first end 6a of the boom 6 and the second support arrangement 10 is provided at the second end 6b of the boom 6.

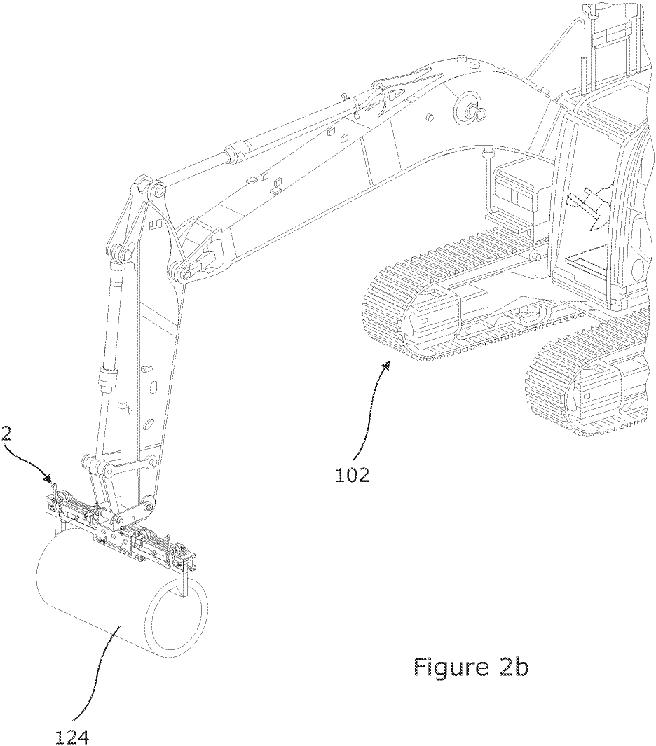

With reference to FIG. 4b, the boom 6 is a telescopic boom including an outer stationary arm 14, a first inner moving arm 16 and a second inner moving arm 18. As will be explained in further detail below, the distance D between the first support arrangement 8 and the second support arrangement 10 can be varied by extending and/or retracting the telescopic boom 6.

The first inner moving arm 16 is arranged to extend from the first end 6a of the boom 6 and the second inner moving arm 18 is arranged to extend from the second end 6b of the boom 6. In other words, the boom 6 is arranged such that it can be extended and/or retracted at each of the first and second ends 6a,b. In other words, a distance between the first end 6a of the boom 6 and the second end 6b of the boom 6 can be increased or decreased by extending and/or retracting one or both of the first inner moving arm 16 and second inner moving arm 18.

In some embodiments, the first inner moving arm 16 and the second inner moving arm 18 are arranged to extend and/or retract in unison.

As shown in FIG. 1b, the mounting component 4 is provided substantially midway between the first and second ends 6a, b of the boom 6 (i.e. when fully extended or fully retracted), in other words midway along the outer stationary arm 14, such that the first end 6a and the second end 6b are both free ends of the boom 6 and are distal each other.

As can be seen from FIG. 3, the first support arrangement 8 is provided at a free end of the first inner moving arm 16. Similarly, the second support arrangement 10 is provided at a free end of the second inner moving arm 18. In other words, the first support arrangement 8 is provided at the first end 6a of the boom 6 and the second support arrangement 10 is provided at the second end 6b of the boom 6.

The adjustment mechanism 12 includes a first pulley arrangement 20 configured to extend and/or retract the telescopic boom 6. The first pulley arrangement 20 is configured to extend and/or retract the telescopic boom 6 at its first end 6a by moving the first inner moving arm 16 with respect to the outer stationary arm 14. In this way, the distance between the first and second ends 6a,b of the boom 6, and hence the distance D between the first and second support arrangements 8,10, is adjusted.

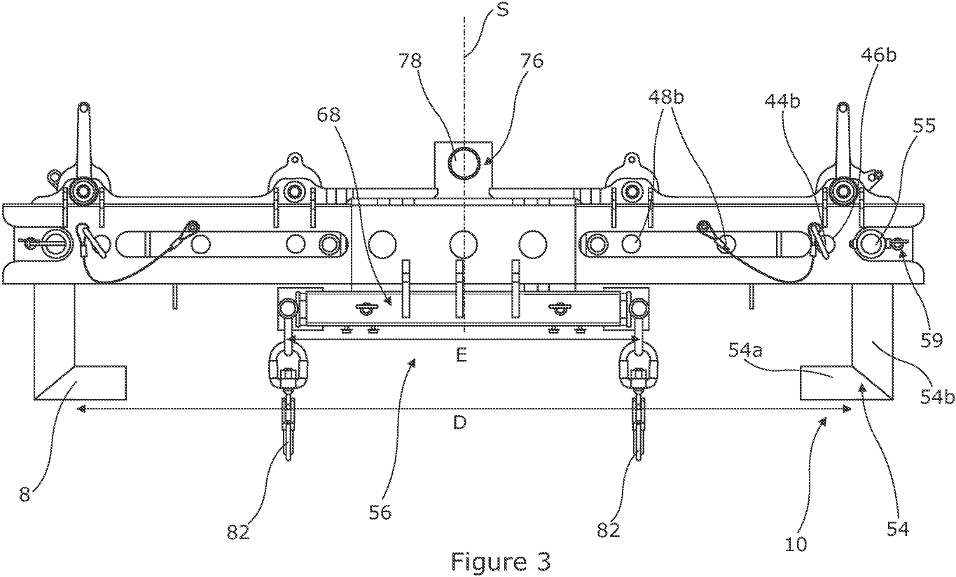

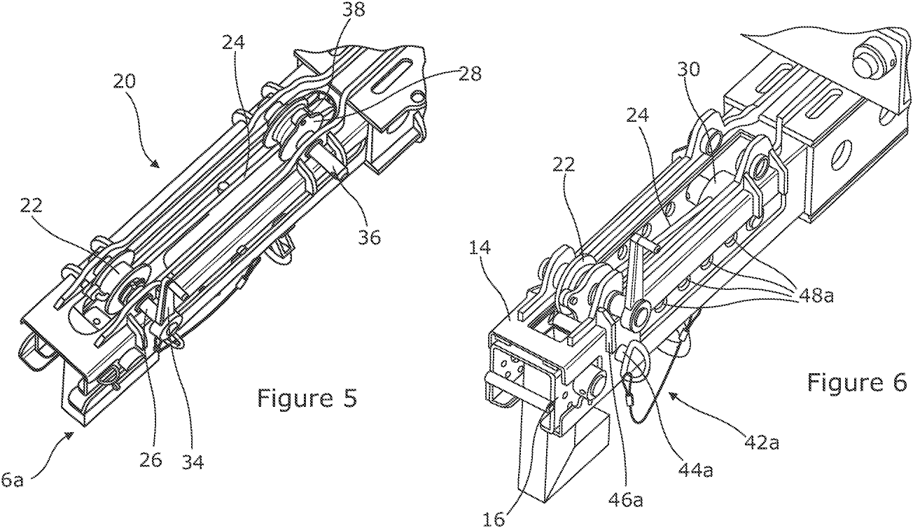

With reference to FIGS. 5 to 8, the first inner moving arm 16 and the outer stationary arm 14 are coupled via the first pulley arrangement 20. The first pulley arrangement 20 includes a first pulley wheel 22 and a first cable 24. As will be described in further detail below, the first pulley arrangement 20 is configured so that rotation of the first pulley wheel 22 causes relative movement of the first inner moving arm 16 and the outer stationary arm 14, wherein the first inner moving arm 16 is guided in the outer stationary arm 14.

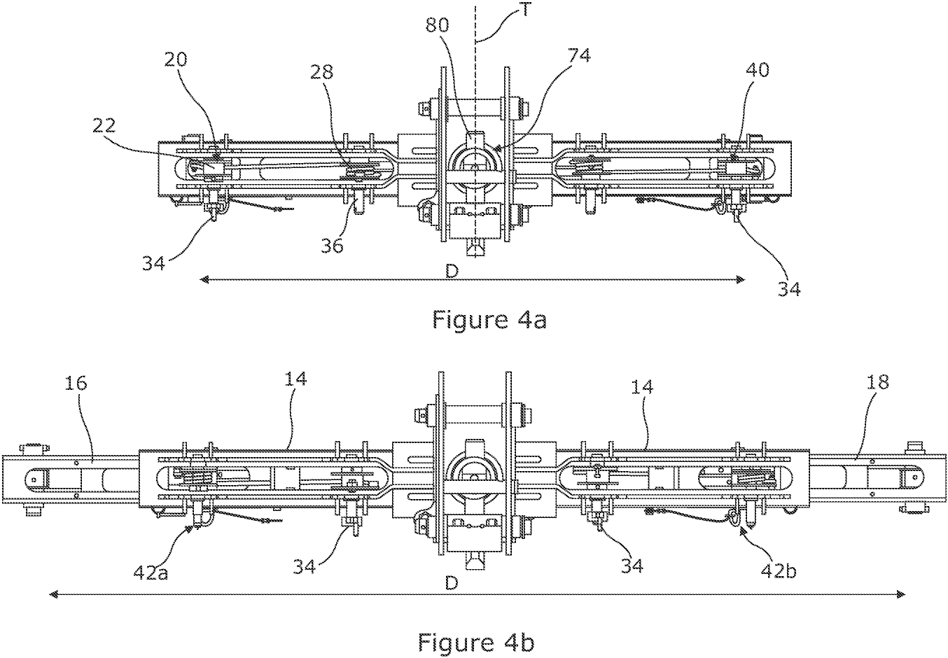

The first pulley wheel 22 is mounted on the outer stationary arm 14 and arranged for rotation about a shaft 26, which extends perpendicularly to the longitudinal axis L of the boom 6. The first cable 24 is coupled to the first inner moving arm 16. With reference to FIG. 6 (in which a second pulley wheel 28 is not shown for the sake of clarity) the first cable 24 is attached to a ring 30 through which a shaft 32 extends to secure the ring 30 in a substantially fixed linear relationship with respect to the first inner moving arm 16. The shaft 32 is fixed to the first inner moving arm 16.

The first cable 24 is coupled to the ring 30 at a first end and to the first pulley wheel 22 at a second end. The adjustment mechanism 12 includes a handle 34 coupled to the shaft 26 of the first pulley wheel 22 such that, as the handle 34 is cranked, the shaft 26 and hence first pulley wheel 22 is rotated, causing the first cable 24 to be wound onto the first pulley wheel 22. In doing so the ring 30 is drawn towards the first pulley wheel 22 causing the first inner moving arm 16 to move in a first linear direction and therefore extend out of the outer stationary arm 14. In this way, the length of the boom 6 is increased. Hence the distance D between the first support arrangement 8 and the second support arrangement 10 is also increased enabling the pipe handling attachment 2 to support pipes of an increased length.

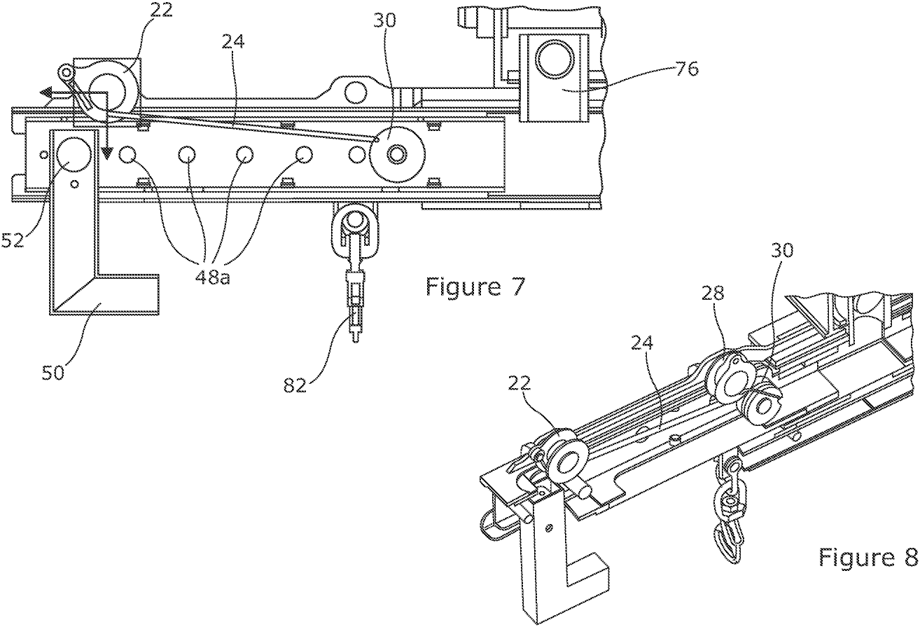

With reference to FIGS. 5 and 8, the first pulley arrangement 20 also includes a second pulley wheel 28 mounted on the outer stationary arm 14 via a shaft 36. The second pulley wheel 28 is coupled to the first inner moving arm 16 via a second cable 38. A first end of the second cable 38 is coupled to the ring 30 and a second end of the cable 38 is coupled to the second pulley wheel 28 such that rotation of the second pulley wheel 28 causes the second cable 38 to be wound onto the second pulley wheel 28. In doing so, the ring 30 is drawn towards the second pulley wheel 28 causing the first inner moving arm 16 move in a second linear direction (opposite the first direction) so that the first inner moving arm 16 retracts into the outer stationary arm 14. In this way, the length of the boom 6 is decreased. Hence the distance D between the first support arrangement 8 and the second support arrangement 10 is also decreased enabling the pipe handling attachment 2 to support pipes of shorter length.

In the embodiment of FIGS. 5 to 8, the first inner moving arm 16 is extended by rotation of the first pulley wheel 22 and retraction of the first inner moving arm 16 is achieved by rotation by the second pulley wheel 28. It will be appreciated that, when fully retracted, rotation of the first pulley wheel 22 in either a clockwise or anti-clockwise direction will cause the first cable 24 to be wound onto the first pulley wheel 22, causing extension of the first inner moving arm 16. Similarly, when fully extended, rotation of the second pulley wheel 28 in either a clockwise or anti-clockwise direction will cause the second cable 38 to be wound onto the second pulley wheel 28, thereby causing retraction of the first inner moving arm 16.

As can be seen from FIG. 4b, handle 34 can be detached from the first pulley wheel 22 and attached to the shaft 36 of the second pulley wheel 28 so that the second pulley wheel 28 can be rotated manually.

Also as is apparent from FIGS. 4a and 4b, the second inner moving arm 18 and corresponding section of the outer stationary arm 14 is provided with a second pulley arrangement 40 which is substantially the same as the first pulley arrangement 20 for extending and retracting the second inner moving arm 18 with respect to the outer stationary arm 14. This second pulley arrangement 40 will not be described for the sake of brevity.

The first and second pulley arrangements 20,40 are thereby arranged such that the boom 6 can be extended and/or retracted at both its first and second ends 6a,b.

The outer stationary arm 28 may be provided by a single component arranged to house both the first inner moving arm 16 and the second inner moving arm 18, as is shown in the Figures. Alternatively, the outer stationary arm 14 may be formed of two components, for example a first outer stationary arm configured to house the first inner moving arm 16, and a second outer stationary arm configured to house the second inner moving arm 18.

The pipe handling attachment 2 further includes a locking arrangement configured so that, when in a locked state, the locking arrangement inhibits or prevents further adjustment of the distance D between the first support arrangement 8 and the second support arrangement 10.

As shown in FIG. 6, for example, the locking arrangement includes a first locking mechanism 42a provided at the first inner moving arm 16, which includes a pin 44a arranged to extend through a corresponding hole 46a of the outer stationary arm 14, and to extend further through one of a series of holes 48a provided in the first inner moving arm 16. In this way, the first inner moving arm 16 and the outer stationary arm 14 are secured together against relative movement therebetween.

The locking arrangement also includes a second locking mechanism 42b provided at the second inner moving arm 18. The second locking mechanism 42b is similar to the first locking mechanism 42a and includes a pin 44b arranged to extend through a corresponding hole 46b of the outer stationary arm 14, and to extend further through one of a series of holes 48b provided in the second inner moving arm 18 (as shown in FIG. 3). In this way, the second inner moving arm 18 and the outer stationary arm 14 are secured together against relative movement therebetween.

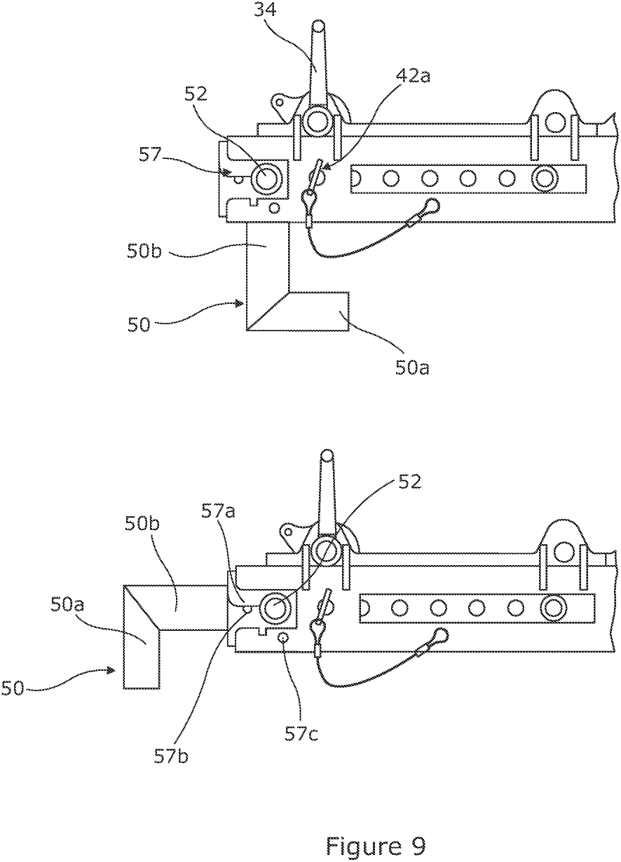

Turning to FIG. 9, the first support arrangement 8 includes a first support projection 50 which is arranged to engage an interior wall of a pipe supported by the pipe handling attachment 2. As can be seen in FIG. 9, the support projection 50 comprises a substantially L shaped profile including seat portion 50a against which an inner wall of a pipe supported by the pipe handling attachment 2 rests when the pipe is supported by the pipe handling attachment 2. The seat portion 50a is pivotably coupled to the first moving arm portion 16 via a strut 50b. The support projection 50 is arranged to rotate about pivot point 52 such that the support projection 50 may be moved into and out of engagement with a pipe, between an engagement position (as shown in the upper image in FIG. 9) and a retracted position (as shown in the lower image in FIG. 9).

The first support arrangement 8 may also include a locking mechanism 57 for securing the support projection 50 in a desired position. For example, when the support projection 50 is positioned to engage a pipe, the locking mechanism may secure the support projection 50 against further movement so to securely support the pipe. With reference to FIG. 9, in the illustrated embodiment the locking mechanism 57 includes a pin 57a and apertures 57b,c in the boom (i.e. the inner moving arm and the outer stationary arm 14) which are configured to correspond with an aperture (not shown) in the support projection 50.

A first of the apertures 57b in the boom is configured to align with the aperture of the support projection 50, when the support projection 50 is in the retracted position. A second of the apertures 57c in the boom is configured to align with the aperture of the support projection 50, when the support projection 50 is in the engagement position.

When the support projection 50 is in the retracted position, the aperture of the support projection aligns with the aperture 57b of the boom 14. The pin 57a is then passed through the aligned apertures to secure the support projection 50 in the retracted position. In this way, the support projection 50 is secured against movement.

When the support projection 50 is in the engagement position, the aperture of the support projection aligns with the aperture 57c of the boom 14. The pin 57a is then passed through the aligned apertures to secure the support projection 50 in the employed position. In this way, the support projection 50 is secured against movement.

The second support arrangement 10 has a similar structure and includes a second support projection 54 which is arranged to engage an interior wall of a pipe supported by the pipe handling attachment 2. As shown in FIG. 3, the second support projection 54 comprises a substantially L shaped profile including seat portion 54a against which an inner wall of a pipe supported by the pipe handling attachment 2 rests when the pipe is supported by the pipe handling attachment 2. The seat portion 54a is pivotably coupled to the second inner moving arm portion 18 via a strut 54b. The second support projection 54 is arranged to rotate about pivot point 55 such that the second support projection 54 may be moved into and out of engagement with a pipe.

The second support arrangement 10 may also include a locking mechanism 59 for securing the second support projection 54 in a desired position, in a similar manner to the first support arrangement 8.

In some embodiments, only one of the first and second support projections 50,54 is configured to pivot with respect to the outer stationary arm 14. For example, the first or second support projection may have a fixed position with respect to the boom 6.

The first support arrangement 8 and the second support arrangement 10 together form a first support structure. The pipe handling attachment 2 also includes a second support structure 56, as shown in FIG. 3, for supporting a pipe. In the illustrated embodiment, the second support structure 56 is arranged to support a pipe at a third portion of the pipe and also at a fourth portion of the pipe.

The second support structure 56 includes a third support arrangement 58, arranged to support a pipe at a third portion of the pipe, and a fourth arrangement 60, arranged to support a pipe at a fourth portion of the pipe.

The third and fourth support arrangements 58,60 each include a hook 82 arranged to support a rope, cable, belt and/or chain for supporting a pipe. The third support arrangement 58 includes a hook 82 and rope, cable, belt and/or chain arranged to support a pipe at a third portion of the pipe. Similarly, the fourth support arrangement 60 includes a hook 82 and rope, cable, belt and/or chain arranged to support the pipe at a fourth portion of the pipe. The third and fourth support arrangements 58,60 are located between the first and second support arrangements 8,10.

The second support structure 56 includes a second adjustment mechanism arranged to adjust a distance E between the third support arrangement 58 and the fourth support arrangement 60. The second adjustment mechanism is arranged to be operated manually.

In the illustrated embodiment, the pipe handling attachment 2 includes a second telescopic boom 62, provided substantially parallel to the main boom 6 and which is shorter that the main boom 6 such that first and second ends 62a,b of the second boom are provided between the first and second ends 6a,b of the main boom 6 (in particular between first and second ends of the outer stationary arm 14).

The third support arrangement 58 and the fourth support arrangement 60 are provided at either end of the second telescopic boom 62 and are arranged so that the distance E between the third and fourth support arrangements 58,60 is variable by extending and/or retracting the second telescopic boom 62.

The second boom 62 includes a first inner moving arm 63a and a second inner moving arm 63b configured to extend from distal ends of a stationary arm 65 of the second boom. The third support arrangement is provided at a distal end of the first inner arm of the second boom. The fourth support arrangement is provided at a distal end of the second inner moving arm of the second boom.

In the illustrated embodiments, the second telescopic boom 62 is configured to be extended and/or retracted by respectively pulling and/or pushing one or both ends of the second telescopic boom 62. Such pulling and/or pushing can be carried out manually. Alternatively, one or more pulley arrangements similar to those described in relation to the first inner moving arm and second inner moving arm 16,18 of the main boom 6 may be applied to one or both ends of the second boom 62.

The pipe handling attachment 2 is coupled to the working machine 100 via a mounting component 4. The mounting component 4 includes substantially U-shaped bracket 64 having a base plate 66 from which a pair of side walls 68 extend.

Each of the side walls 68 includes a first aperture 70 for coupling to the second end 112b of the second arm 112, and a second aperture 72 for coupling to the linkage mechanism 126 of the arm assembly 108.

The base plate 66 includes an aperture 74 (see FIG. 4a) for coupling the U-shaped bracket 64 to the main boom 6 of the pipe handling attachment 2. A mounting projection 76 extends from the main boom 6 at approximately the mid-point of the outer stationary arm 14 of the boom 6. The mounting projection 76 is arranged to extend through the corresponding aperture 74 in the base plate 66. It will be appreciated that the pipe handling attachment 2 is configured for rotation about said mounting projection 76 about a second axis S (see FIG. 3). This can be thought of as rotation about a yaw axis.

The mounting projection 76 further comprises an aperture 78 through which a pin 80 may be fitted to secure the boom 6 to the U-shaped bracket 64. It will be appreciated that the mounting projection 76, and hence the pipe handling attachment 2 may be rotated about the mounting pin 80, about an axis T (see FIG. 4a), such that a relative height of the first and second ends 6a,b of the boom 6 may be adjusted to facilitate attachment of the pipe handling attachment 2 to a pipe. This can be thought of as rotation about a roll axis.

It will be appreciated that the pitch of the pipe handling attachment 2 can be varied via movement of the arm assembly 108 of the working machine 100.

When in use, the pipe handling attachment 2 is coupled to the arm assembly 108 of the working machine 100 via the mounting component 4. The second end 112b of the second arm 112 of the arm assembly 108 is coupled to the U-shaped bracket 64 via the first apertures 70 of the side walls 68, e.g. via a pin. The U-shaped bracket 64 is also coupled to the linkage mechanism 126 at the second apertures 72 of the side walls 68, e.g. via a pin.

The mounting projection 76 of the boom 6 is passed through the aperture 74 in the base plate 66 of the U-shaped bracket 64. The pin 80 is passed through the aperture 78 of the projection 76 to secure the U-shaped bracket 64 to the boom 6. In this way, the pipe handling attachment 2 is secured to the working machine 100. The pipe handling attachment 2 can then be used to lift/support/manoeuvre a pipe as required.

To couple the pipe handling attachment 2 to a relatively long pipe, for example having a length in the range of 1-4 metres, for example 1.5 m-3 m, for example 1.5 m-2.6 m, the boom 6 is adjusted such that the distance D between the first support arrangement 8 and the second support arrangement 10 corresponds to the length of the pipe to be lifted. This is achieved by rotation of the handle 34 when coupled to the first pulley wheel 22 or the second pulley wheel 28 as required. For example, to lengthen the distance D, the handle 34 is coupled to the first pulley wheel 22 and cranked such that the first cable 24 is wound onto the first pulley wheel 22, thereby drawing the ring 30 towards the first pulley wheel 22. In this way, the first inner moving arm 16 extends out of the outer stationary arm 14, thereby lengthening the distance D. A similar process may also be followed using the second pulley arrangement 40 to extend the second inner moving arm 18 out of the outer stationary arm 14.

If it is necessary to reduce the distance D between the first support arrangement 8 and the second support arrangement 10, the handle 34 is detached from the shaft of the first pulley wheel 22 and coupled to the shaft 36 of the second pulley wheel 28. The handle 34 is then cranked to rotate the second pulley wheel 28, thereby drawing the ring 30 towards the second pulley wheel 28. This causes the first inner moving arm 16 to be retracted into the outer stationary arm 14. In this way, the distance D is reduced. A similar process may also be followed using the second pulley arrangement 40 to retract the second inner moving arm 18 into of the outer stationary arm 14.

Once the distance D between the first support arrangement 8 and the second support arrangement 10 has been adjusted to correspond to the length of a pipe to be lifted, the locking mechanisms 42a,42b are used to secure the respective first and second inner moving arm 16, 18 against further movement with respect to the outer stationary arm 14. Specifically, the respective pin 44a,b is passed through the respective hole 46a,b of the outer stationary arm 14 and then through an appropriate one of the respective series of holes 48a,b in the respective moving arm 16, 18.

When the length of the boom 6 has been set (i.e. the distance D has been set to the desired length), the pipe handling attachment 2 is manoeuvred such that the longitudinal axis L of the pipe handling attachment 2 is aligned with a longitudinal axis of the pipe.

The first support projection 50 and/or the second support projection 54 is rotated with respect to the boom 6 and located such that an interior wall of the pipe is positioned to rest on the respective seat portions 50a,54a. The first and/or second support projections 50, 54 are then locked in place via the locking mechanisms 57, 59 as described above.

Should further support be required, for example for particularly long and/or heavy pipes, the second support structure 56 may also be used to support the pipe when lifted. To do so, a rope, cable, belt and/or chain, e.g. a belt, is attached to the hook of the third support arrangement 58. Similarly, a rope, cable, belt and/or chain, e.g. a belt, is coupled to the hook of the fourth support arrangement 60. The belts of the third and fourth support arrangements 58, 60 are passed around the outer circumference of the pipe at respective third and fourth portions of the pipe. In this way, additional support for lifting the weight of the pipe is provided.

Once the pipe is coupled to the pipe handling attachment 2, the working machine 100 may be operated to move the arm assembly 108 and hence lift and manipulate the position of the pipe handling attachment 2 in order to move the pipe to the desired location.

Once the pipe is in the desired position, the pipe handling attachment 2 is disengaged from the pipe by moving the support projection 50 of the first support arrangement 8 and/or the support projection 54 of the second support arrangement 10 out of engagement with the pipe. This is achieved by manually moving one or both of the first and second support projections 50,54 away from the pipe via rotation of the respective support projection 50,54 with respect to the boom 6. The belts of the third and fourth support arrangements 58, 60 are removed from around the pipe. The pipe handling attachment 2 can then be moved away from the pipe via movement of the arm assembly 108.

In some cases, the second support structure 56 may not be required and the pipe is lifted and manoeuvred using only the first support structure.

In some cases, the pipe to be lifted may be shorter in length that the minimum distance between the first and second support arrangements 8, 10. For example, having a length less than 0.5 m, e.g. less than 1 m, e.g. less than 1.5 m. In such cases, only the second support structure 58 is used to lift the pipe.

In some cases, it may be preferable to only use the second support structure 58 to lift the pipe. The second support structure 58 can be used to support pipes having length of 0.3 m or greater, for example, 0.5 m or greater.

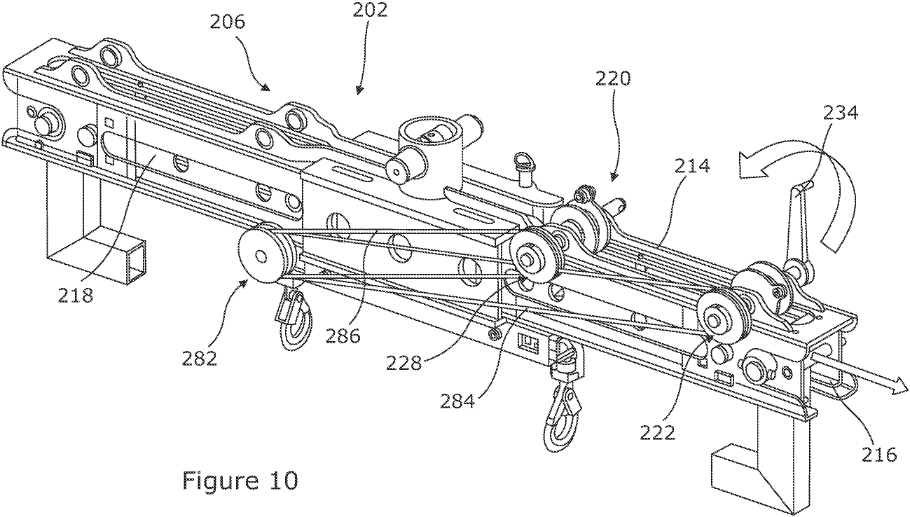

With reference to FIG. 10, a second embodiment of a pipe handling attachment 202 is shown.

The pipe handling attachment 202 of the second embodiment is similar to the pipe handling attachment 2 previously described. Accordingly, only the differences will be described below for the sake of brevity.

In the pipe handling attachment 202, a single pulley arrangement 220 is provided in order to effect extension and/or retraction of both ends of the boom 206. The pulley arrangement 220 includes a first pulley wheel 222 and a second pulley wheel 228. These are attached to the outer stationary arm 214 of the boom 206 and coupled to the first inner moving arm 216 in the same manner as previously described.

The pulley arrangement 220 also includes a third pulley wheel 282 which is coupled to the first pulley wheel 222 by a third cable 284 and to the second pulley wheel 228 by a fourth cable 286. The third pulley wheel 282 is coupled to the first and second pulley wheels 222, 228 such that rotation of the first pulley wheel 222 in a first angular direction causes rotation of the second pulley wheel 228 in the same angular direction. Similarly, rotation of the first pulley wheel 222 in a second angular direction causes rotation of the second pulley wheel 228 in the same angular direction. In this way, only rotation of the first pulley wheel 222 is required in order to extend and/or retract the first inner moving arm 216 from the outer stationary arm 214.

In the illustrated embodiment of FIG. 10, rotation of the first pulley wheel 222 in a first angular direction causes the first cable to be wound onto the first pulley wheel 222, thereby causing extension of the first inner moving arm 216 (i.e. movement of the first inner moving arm 216 in a first linear direction). Rotation of the first pulley wheel 222 in a second angular direction causes corresponding rotation of the second pulley wheel 228, causing the second cable 238 to be wound onto the second pulley wheel 228, thereby retracting the first inner moving arm 216 (i.e. movement of the first inner moving arm 216 in a second linear direction).

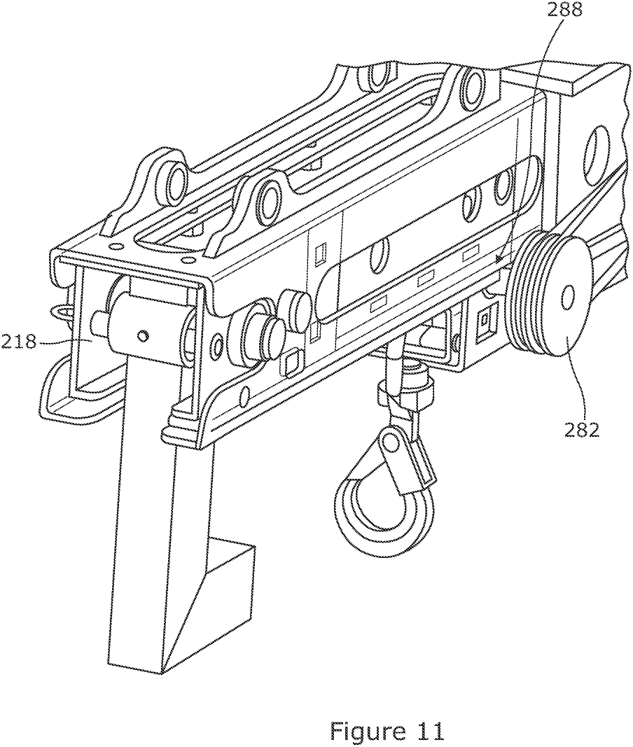

Furthermore, with reference to FIG. 11, the third pulley wheel 282 is coupled to the second inner moving arm 218 via a rack and pinion arrangement 288. In this way, rotation of the first pulley wheel 222 in the first direction causes corresponding rotation of the third pulley wheel 282 in the same direction, resulting in extension of the second inner moving arm 218 (i.e. linear movement of the second inner moving arm 218 in the second linear direction). Similarly, rotation of the first pulley wheel 222 in the second angular direction causes corresponding rotation of the third pulley wheel 282 in the same direction, resulting in retraction of the second inner moving arm 218 (i.e. movement of the second inner moving arm 218 in the first linear direction).

In this way, when the first pulley wheel 222, and hence the third pulley wheel 282, is rotated one way, the second inner moving arm 218 is extended and when the third pulley wheel 282 is rotated the opposite direction, the second inner moving arm 218 is retracted into the stationary outer arm 214.

Consequently, as the first pulley wheel 222 is rotated in a first angular direction, both the first inner moving arm 216 and the second inner moving arm 218 are extended out of the outer stationary arm 214 in unison. When the first and second moving arms 216, 218 are fully retracted, the rack and pinion arrangement 288 is configured such that the handle 234 coupled to the first pulley wheel 222 can only be cranked in one direction. Accordingly, rotation of the first pulley wheel in a first angular direction causes extension of both the first and second inner moving arms 216, 218. Similarly, rotation of the first pulley wheel 222 in the opposite direction causes retraction of both the first and second inner moving arms 216, 218. In this way, only a single handle coupled to only one of the first and second pulley wheels is required in order to extend and/or retract both the inner moving arms.

Although one or more preferred embodiments have been described, it will be appreciated that various changes or modifications may be made without departing from the scope defined in the appended claims. For example, any other suitable mounting arrangement may be used to couple the pipe handling attachment to a working machine. Further, although an excavator has been described herein, it will be appreciated that the pipe handling attachment may be coupled to any suitable working machine.

1. A pipe handling attachment for a working machine, the pipe handling attachment configured to support a pipe and comprising:
a. a mounting component configured to couple the pipe handling attachment to a working machine;
b. a boom having a first support arrangement for supporting a first portion of a pipe, and a second support arrangement, spaced apart from the first support arrangement, for supporting a second portion of said pipe, wherein a distance between the first support arrangement and the second support arrangement is variable; and
c. an adjusting mechanism, configured to adjust the distance between the first support arrangement and the second support arrangement, and wherein the adjusting mechanism is configured to be operated manually.

2. The pipe handling attachment according to claim 1, wherein the attachment means is configured such that, when in use, a longitudinal axis of the boom is substantially parallel to a longitudinal axis of a pipe supported by the pipe handling attachment.

3. The pipe handling attachment according to claim 1, wherein the first support arrangement is provided at a first end of the boom and the second support arrangement is provided at a second end of the boom, distal the first end.

4. The pipe handling attachment according to claim 1, wherein the boom is a telescopic boom comprising an outer stationary arm and a first inner moving arm configured to extend from a first end of the boom, and arranged such that the distance between the first support arrangement and the second support arrangement is varied by extending and/or retracting the telescopic boom.

5. The pipe handling attachment according to claim 4, wherein the adjustment mechanism comprises a first pulley arrangement having a pulley wheel and a rope, cable, belt and/or chain.

6. The pipe handling attachment according to claim 5, wherein the first inner moving arm and the outer stationary arm are coupled via the first pulley arrangement, wherein the first pulley arrangement is configured such that rotation of the pulley wheel causes relative movement of the first inner moving arm and outer stationary arm.

7. The pipe handling attachment according to claim 6, wherein the pulley wheel is mounted on the outer stationary arm or the first inner moving arm and is configured to be rotated manually about a shaft, and the rope, cable, belt and/or chain is coupled to the other of the outer stationary arm and the first inner moving arm, such that rotation of the pulley wheel causes movement of the fist inner moving arm in a linear direction.

8. The pipe handling attachment according to claim 5, wherein the pulley wheel is a first pulley wheel, and the first pulley arrangement comprises a second pulley wheel, wherein both the first and second pulley wheels are mounted on the outer stationary arm or the first inner moving arm, the first pulley wheel and the second pulley wheel each being configured for rotation about a respective shaft, such that rotation of the first pulley wheel and/or second pulley wheel (e.g. in a first angular direction) causes movement of the first inner moving arm in a first linear direction and/or rotation of the first pulley wheel and/or second pulley wheel (e.g.in a second angular direction) causes movement of the inner moving arm in a second linear direction.

9. The pipe handling attachment according to claim 8, wherein the first pulley wheel and/or second pulley wheel is configured to be rotated manually.

10. The pipe handling attachment according to claim 4, wherein the boom comprises a second inner moving arm configured to extend from a second end of the boom, such that the boom is configured to extend and/or retract at both the first and second ends.

11. The pipe handling attachment according to claim 10, wherein the second inner moving arm and the outer stationary arm are coupled via a second pulley arrangement wherein the second pulley arrangement is configured to cause relative movement of the second inner moving arm and outer stationary arm, optionally, wherein the second pulley arrangement is substantially the same as the first pulley arrangement.

12. The pipe handling attachment according to claim 10, wherein the first inner moving arm and the second inner moving arm are arranged to extend and/or retract in unison.

13. The pipe handling attachment according to claim 10, wherein the first pulley attachment comprises a third pulley wheel coupled to the first and second pulley wheels respectively, such that rotation of the first pulley wheel in the first angular direction causes rotation of the second pulley wheel in the first angular direction, and/or rotation of the first pulley wheel in the second angular direction causes rotation of the second pulley wheel in the second angular direction.

14. The pipe handling attachment according to claim 13, wherein rotation of the first and/or second pulley wheel in a first angular direction causes movement of the first inner moving arm in a first linear direction and rotation of the first and/or second pulley wheel in a second angular direction causes movement of the inner moving arm in a second linear direction.

15. The pipe handling attachment according to claim 14, wherein the second inner moving arm is coupled to the third pulley (e.g. via a rack and pinion arrangement), such that rotation of the first and/or second pulley wheel in the first angular direction causes movement of the second inner moving arm in the second linear direction, and/or rotation of the first and/or second pulley wheel in the second angular direction causes movement of the second inner moving arm in the first linear direction.

16. The pipe handling attachment according to claim 10, wherein the first support arrangement is provided at a free end of the first inner moving arm and the second support arrangement is provided at a free end of the second inner moving arm; optionally, wherein the first support arrangement and second support arrangement each comprise a support projection configured to engage an interior wall of a pipe supported by the pipe handling attachment, wherein at least one of the support projections is pivotally mounted on the boom and configured for manual rotation.

17. The pipe handling arrangement according to claim 1, wherein the pipe handling attachment comprises a locking arrangement configured such that, when in a locked state, the locking arrangement inhibits or prevents adjustment of the distance between the first support arrangement and the second support arrangement.

18. The pipe handling attachment according to claim 1, wherein the first support arrangement and the second support arrangement comprise a first support structure, and wherein the pipe handling attachment further comprises a second support structure configured to support said pipe at a third portion of said pipe, and optionally at a fourth portion of said pipe; optionally, where in the second support structure comprises a third support arrangement for supporting the third portion of said pipe, optionally wherein the secondary support structure also comprises a fourth support arrangement for supporting the fourth portion of said pipe, wherein the third support arrangement, and optionally the fourth support arrangement, are located between the first and second support arrangements; optionally, wherein the second support structure comprises a fourth support arrangement, wherein the adjusting mechanism is a first adjusting mechanism, and wherein the pipe handling attachment comprises a second adjusting mechanism configured to adjust a distance between the third support arrangement and the fourth support arrangement, and wherein the second adjusting mechanism is configured to be operated manually; optionally, where the boom is a first boom and wherein the second support structure comprises a second boom, wherein the second boom is a telescopic boom configured such that the distance between the third support arrangement and fourth support arrangement is variable by extension and/or retraction of the second telescopic boom; optionally, where in the third support arrangement comprises a rope, cable, belt and/or chain for supporting said pipe at said third portion, optionally wherein the second support structure comprises a fourth support arrangement and wherein the fourth support arrangement comprises a belt for supporting said pipe at said fourth portion.

19. A pipe handling attachment according to claim 1, wherein the pipe handling attachment defines a longitudinal axis along which the first support arrangement and the second support arrangement are provided, wherein the mounting arrangement is configured to permit rotation of the pipe handling attachment about a second axis substantially perpendicular to said longitudinal axis; optionally, wherein the pipe handling attachment defines a longitudinal axis along which the first support arrangement and the second support arrangement are provided, wherein the mounting arrangement is configured to permit rotation of the pipe handling attachment about a third axis substantially perpendicular to the longitudinal axis and the second axis.

20. A pipe handling attachment according to claim 1, in combination with a working machine.
